(19) United States
(12) Patent Application Publication
(10) Pub. No.: US 2016/0258816 A1
(43) Pub. Date: Sep. 8, 2016

(54) OPTICAL METHOD FOR MONITORING PLASMA DISCHARGING GLOW

(71) Applicant: CREATING NANO TECHNOLOGIES, INC., Tainan City (TW)

(72) Inventors: Ji-Yung LEE, TAINAN CITY (TW); Yi-Ming HSU, TAINAN CITY (TW); Li-Min WANG, TAINAN CITY (TW); Yu-Chun HUANG, KAOHSIUNG CITY (TW); Yen-Cheng CHEN, TAICHUNG CITY (TW)

(21) Appl. No.: 14/849,567

(22) Filed: Sep. 9, 2015

(30) Foreign Application Priority Data
Mar. 4, 2015 (TW) 104106853

(51) Int. Cl. G01J 3/443; G01J 1/42

(52) U.S. Cl. CPC G01J 3/443; G01J 1/42

(57) ABSTRACT

An optical method for monitoring plasma discharging glow is described, which includes the following steps. Plasma discharging glow is detected to obtain various optical signals using a detector. The optical signals are captured and converted into various electric signals by using a sensing circuit. A calculation step is performed according to the electric signals to obtain various light intensities corresponding to various locations in the plasma discharging glow using an arithmetic unit. An image of the plasma discharging glow is reconstructed according to the locations in the plasma discharging glow and the corresponding light intensities using an image reconstruction unit.

### RELATED APPLICATIONS

This application claims priority to Taiwan Application Serial Number 104106853, filed Mar. 4, 2015, which is herein incorporated by reference.

### BACKGROUND

1. Field of Invention

The present invention relates to a monitor technique. More particularly, the present invention relates to an optical method for monitoring plasma discharging glow.

2. Description of Related Art

Properties of plasma generated by a plasma device can be used to estimate performance of the plasma device. Currently, in analysis techniques of plasma properties, a grating spectrometer is generally used to detect and analyze types of plasma. However, when the grating spectrometer is used to perform a detecting operation, only species and relative intensities of plasma can be got, but a shape and an absolute intensity of the plasma cannot be got.

In addition, nowadays, a technique that can accurately estimate a size and a shape of the plasma has not been developed. Furthermore, there is no technique that can directly estimate intensity distribution of the plasma.

### SUMMARY

Therefore, one objective of the present invention is to provide an optical method for monitoring plasma discharging glow, which can effectively detect a shape, a size, temperature distribution, color distribution, a rotating speed, flash behavior, relative intensities, an absolute intensity and intensity distribution of the plasma discharging glow by a non-contact method, thereby achieving an effect of immediately monitoring a plasma treating region.

Another objective of the present invention is to provide an optical method for monitoring plasma discharging glow, which can rapidly estimate properties of the plasma discharging glow.

Still another objective of the present invention is to provide an optical method for monitoring plasma discharging glow, which may use a charge coupled device (CCD) as a detector for detecting the plasma discharging glow, thereby reducing monitoring cost.

According to the aforementioned objectives, the present invention provides an optical method for monitoring plasma discharging glow, which includes the following steps. Plasma discharging glow is detected to obtain various optical signals using a detector. The optical signals are captured and converted into various electric signals by using a sensing circuit. A calculation step is performed according to the electric signals to obtain various light intensities corresponding to various locations in the plasma discharging glow using an arithmetic unit. An image of the plasma discharging glow is reconstructed according to the locations in the plasma discharging glow and the corresponding light intensities using an image reconstruction unit.

According to one embodiment of the present invention, the detector includes a charge coupled device.

According to another embodiment of the present invention, the detector includes a charge coupled device and an optical emission spectrometer (OES).

According to still another embodiment of the present invention, the detector includes a charge coupled device and a power meter.

According to further another embodiment of the present invention, the optical signals include a plurality of photoelectron intensities.

### BRIEF DESCRIPTION OF THE DRAWINGS

These and other objectives, features, advantages and embodiments of the present invention will become better understood with reference made to the accompanying drawings as follows:

FIG. 1 is a flow chart of an optical method for monitoring plasma discharging glow in accordance with one embodiment; and

FIG. 2 is a schematic drawing of a device for optically monitoring plasma discharging glow in accordance with one embodiment of the present invention.

### DETAILED DESCRIPTION

In view of there is no technique, which can accurately estimate size and shape of plasma, and there is either no technique, which can directly estimate an absolute intensity of plasma. Thus, embodiments of the present disclosure provide an optical method for monitoring plasma discharging glow, which uses an optical method to detect plasma discharging glow, so that properties of the plasma discharging glow, such as a shape, a size, temperature distribution, color distribution, a rotating speed, flash behavior, relative intensities, an absolute intensity and intensity distribution are effectively and rapidly estimated by a non-contact method. Therefore, an effect of immediately monitoring a plasma treating region is achieved. Moreover, the embodiments of the present disclosure may use a charge coupled device to detect photoelectron intensities of the plasma discharging glow, thereby reducing monitoring cost.

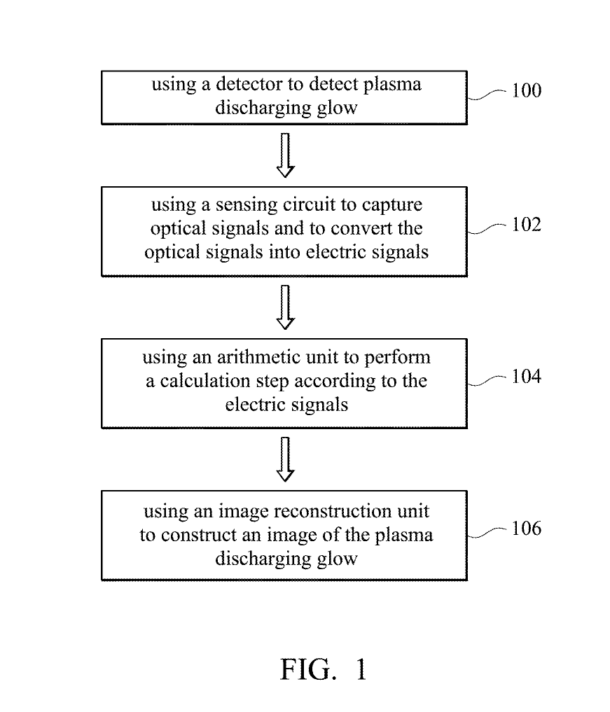

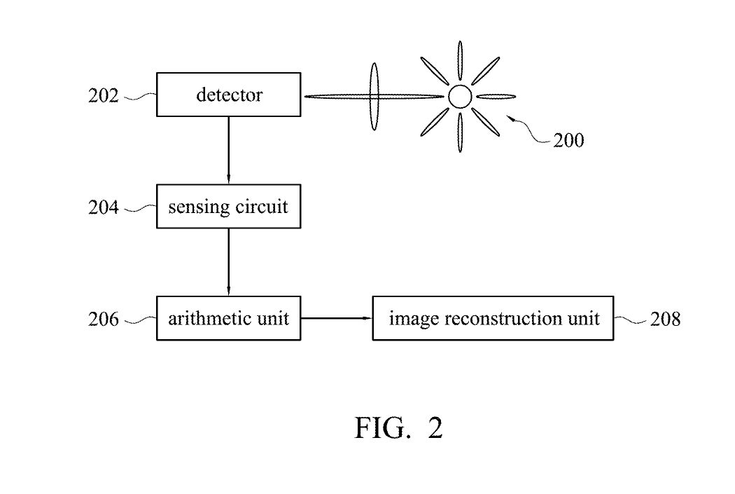

Referring to FIG. 1 and FIG. 2, in which FIG. 1 is a flow chart of an optical method for monitoring plasma discharging glow in accordance with one embodiment, and FIG. 2 is a schematic drawing of a device for optically monitoring plasma discharging glow in accordance with one embodiment of the present invention. In the present embodiment, when an optical method is used to monitor properties of plasma discharging glow 200, a step 100 may be firstly performed to collect optical signals of photoelectrons emitted by the plasma discharging glow 200 using a detector 202. The operation of using the detector 202 to collect the optical signals of the photoelectrons emitted by the plasma discharging glow 200 may include detecting where the photoelectrons emitted from the plasma discharging glow 200 and intensities of the photoelectrons.

In some examples, the detector 202 may include a charge coupled device. The charge coupled device can detect flash behavior of the plasma discharging glow 200, such as flash numbers and flash frequency, so that stability and quality of the plasma discharging glow 200 can be known. In some certain examples, the charge coupled device can also detect a rotating speed of the plasma discharging glow 200 when the plasma discharging glow 200 is generated by a rotating plasma device. In addition, the charge coupled device can detect a RGB value of the plasma discharging glow 200 for determining whether the color of the plasma discharging glow 200 fits a requirement or not. In some examples, the detector 202 may simultaneously include a charge coupled device and an optical emission spectrometer, in which the optical emission spectrometer can detect species and a relative intensity corresponding to each of the species. In some examples, the detector 202 may simultaneously include a charge coupled device and a power meter, in which the power meter can detect an absolute intensity of the whole plasma discharging glow 200.

As shown in FIG. 1 and FIG. 2, after the collection of the optical signals of the plasma discharging glow 200 is completed, a step 102 may be performed to use a sensing circuit 204 to capture the optical signals collected by the detector 202 and to convert the optical signals into various corresponding electric signals. In the step 102, the sensing circuit 204 respectively converts the optical signals in the intensities of the photoelectrons emitted from various locations in the plasma discharging glow 200 to the corresponding electric signals in current intensities. In some examples, the sensing circuit 204 may be disposed on the detector 202, and the sensing circuit 204 is electrically connected to the detector 202 for capturing the optical signals from the detector 202.

Referring to FIG. 1 and FIG. 2 again, after the capturing and converting of the optical signals are completed, a step 104 may be performed to use the sensing circuit 204 to transmit the electric signals obtained after converting to an arithmetic unit 206, and to use the arithmetic unit 206 to sort the electric signals and to calculate according to the electric signals to obtain various light intensities respectively corresponding to various locations of the plasma discharging glow 200. That is to say, in the step 104, after being sorted and calculated by the arithmetic unit 206, a signal corresponding to a light intensity from each of the locations in the plasma discharging glow 200 can be obtained. It also means that, after sorting and calculating, electric signal distribution of the light intensities of the plasma discharging glow 200 can be obtained. Thus, a shape, a size, color distribution, an absolute intensity and relative intensities of the plasma discharging glow 200 can be obtained according to the electric signal distribution of the light intensities, and temperature distribution of the plasma discharging glow 200 can be further obtained according to the light intensity distribution of the plasma discharging glow 200. In addition, a rotating speed and flash behavior of the plasma discharging glow 200 is obtained from variations of the light intensity distributions in various detecting operations. In some examples, the arithmetic unit 206 is electrically connected to the sensing circuit 204, so that it is beneficial for the sensing circuit 204 to transmit the electric signals converted from the optical signals to the arithmetic unit 206.

With regard to calculation and analysis for RGB values in the optical signals of the plasma discharging glow 200 detected by the charge coupled device, the arithmetic unit 206 may individually calculate an R value, a G value and a B value, or may collectively calculate the combination of the R value, the G value and the B value.

Simultaneously referring to FIG. 1 and FIG. 2 again, after the electric signals are sorted and calculated by the arithmetic unit 206 to obtain the electric signal distribution of the light intensities of the plasma discharging glow 200, a step 106 may be performed to use the arithmetic unit 206 to transmit the information of the electric signal distribution of the light intensities of the plasma discharging glow 200 to an image reconstruction unit 208. A reconstructing operation is performed according to the locations in the plasma discharging glow 200 and the information of the electric signal distribution of the light intensities corresponding to the locations by using the image reconstruction unit 208, so as to reconstruct an image of the detected plasma discharging glow 200. In some examples, the operation of reconstructing the image of the plasma discharging glow 200 includes using an optimization method, such as a method for removing image noises or a method for adjusting a background, to make the reconstructed image of the plasma discharging glow 200 clearer. The image reconstruction unit 208 is electrically connected to the arithmetic unit 206, and thus it is beneficial for the arithmetic unit 206 to transmit the electric signal distribution of the light intensities of the plasma discharging glow 200 to the image reconstruction unit 208. The reconstructed image of the plasma discharging glow 200 may be shown on a display, such that a plasma treating region treated using the plasma discharging glow 200 is immediately monitored. Therefore, it is beneficial for staffs online to estimate performance of the plasma device, thereby further enhancing yield of the plasma treatment procedure.

According to the aforementioned embodiments, one advantage of the present invention is that an optical method for monitoring plasma discharging glow of the present invention can effectively detect a shape, a size, temperature distribution, color distribution, a rotating speed, flash behavior, relative intensities, an absolute intensity and intensity distribution of the plasma discharging glow by a non-contact method, so that an effect of immediately monitoring a plasma treating region is achieved.

According to the aforementioned embodiments, another advantage of the present invention is that an optical method for monitoring plasma discharging glow of the present invention can rapidly estimate properties of the plasma discharging glow.

According to the aforementioned embodiments, still another advantage of the present invention is that an optical method for monitoring plasma discharging glow of the present invention may use a charge coupled device as a detector for detecting the plasma discharging glow, so that monitoring cost is reduced.

Although the present invention has been described in considerable detail with reference to certain embodiments thereof, the foregoing embodiments of the present invention are illustrative of the present invention rather than limiting of the present invention. It will be apparent to those having ordinary skill in the art that various modifications and variations can be made to the present invention without departing from the scope or spirit of the invention. Therefore, the spirit and scope of the appended claims should not be limited to the description of the embodiments contained herein.

What is claimed is:

1. An optical method for monitoring plasma discharging glow, comprising:
detecting a plasma discharging glow using a detector to obtain a plurality of optical signals;
capturing the optical signals and converting the optical signals into a plurality of electric signals using a sensing circuit;
performing a calculation step according to the electric signals to obtain a plurality of light intensities corresponding to a plurality of locations in the plasma discharging glow using an arithmetic unit; and
reconstructing an image of the plasma discharging glow according to the locations in the plasma discharging glow and the corresponding light intensities using an image reconstruction unit.

2. The optical method for monitoring plasma discharging glow of claim 1, wherein the detector comprises a charge coupled device.

3. The optical method for monitoring plasma discharging glow of claim 1, wherein the detector comprises a charge coupled device and an optical emission spectrometer.

4. The optical method for monitoring plasma discharging glow of claim 1, wherein the detector comprises a charge coupled device and a power meter.

5. The optical method for monitoring plasma discharging glow of claim 1, wherein the optical signals comprise a plurality of photoelectron intensities.
